(19) United States
(12) Patent Application Publication
(10) Pub. No.: US 2016/0324085 A1
(43) Pub. Date: Nov. 10, 2016

(54) HANGING PLANT WATERING DEVICE

(71) Applicant: Eugene Potempa, Lake Zurich, IL (US)

(72) Inventor: Eugene Potempa, Lake Zurich, IL (US)

(21) Appl. No.: 14/705,079

(22) Filed: May 6, 2015

(51) Int. Cl. A01G 27/00; A47G 7/04

(52) U.S. Cl. CPC A01G 27/008; A47G 7/044

(57) ABSTRACT

A hanging basket watering device is provided. The present invention includes a hook protruding from a bottom portion of a housing. A portion of the hook is resiliently retained within the housing. A tubing also extends from the bottom portion of the housing. A valve is disposed within the tubing. The valve is operable to close when a threshold force is applied against the resiliency of the hook and open when the threshold force is not being applied. Therefore, when a plant that is hanging from the hook becomes lighter due to evaporation, the valve opens and the tubing delivers water until the threshold force is reached.

### BACKGROUND OF THE INVENTION

The present invention relates to plants within hanging baskets and, more particularly, to a watering device for plants within hanging baskets.

A hanging basket is a suspended container used for growing decorative plants. Typically they are hung from buildings, where garden space is at a premium, and from street furniture for environmental enhancement. They may also be suspended from free standing frames sometimes called hanging basket trees. Providing a proper amount of water to the hanging basket plant may be difficult. Too much water causes disease and poor plant health and too little water kills the plants.

A common self watering system includes a watering timer. However, a timer delivers water to the plant regardless of whether the plant actually needs the water. For example, hanging basket plants are usually hung outdoors. Therefore, when it rains, the timer may be initiated and the plant may be overwatered.

As can be seen, there is a need for a water delivery system based on the needs of the plant.

### SUMMARY OF THE INVENTION

In one aspect of the present invention, a hanging basket watering device comprises: a housing; a first hook comprising a body and a head, wherein the head is protruding from a bottom portion of the housing and the body is slidably engaged with and resiliently retained within the housing; an interior tube comprising at least a portion fixed within the housing; an exterior tube surrounding and slidably engaged with the interior tube; a bracket fixedly connecting the exterior tube and the second hook together near the bottom portion of the housing; and a valve fluidly connected with the interior tube, wherein the valve is operable to close when a threshold force is applied against the resiliency of the first hook.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a cutaway perspective view of an embodiment of the present invention;

FIG. 3 is a section view of the present invention along line 3-3 in FIG. 1 with the present invention in a non-dispensing configuration;

FIG. 4 is a section detail view of the present invention in a non-dispensing configuration;

FIG. 5 is a section view of the present invention in a dispensing configuration; and

FIG. 6 is a detail section view of the present invention in a dispensing configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hanging basket watering device. The present invention includes a hook protruding from a bottom portion of a housing. A portion of the hook is resiliently retained within the housing. A tubing also extends from the bottom portion of the housing. A valve is disposed within the tubing. The valve is operable to close when a threshold force is applied against the resiliency of the hook and open when the threshold force is not being applied. Therefore, when a plant that is hanging from the hook becomes lighter due to evaporation, the valve opens and the tubing delivers water until the threshold force is reached.

The present invention includes a watering system to accurately water a hanging basket used for growing plants and vegetables. The present invention provides a correct amount of water to the plant and once the plant dries, the delivery system again provides water. Using the system of the present invention, the plant is watered at an appropriate time which causes the plant to grow bigger, stronger and more beautiful.

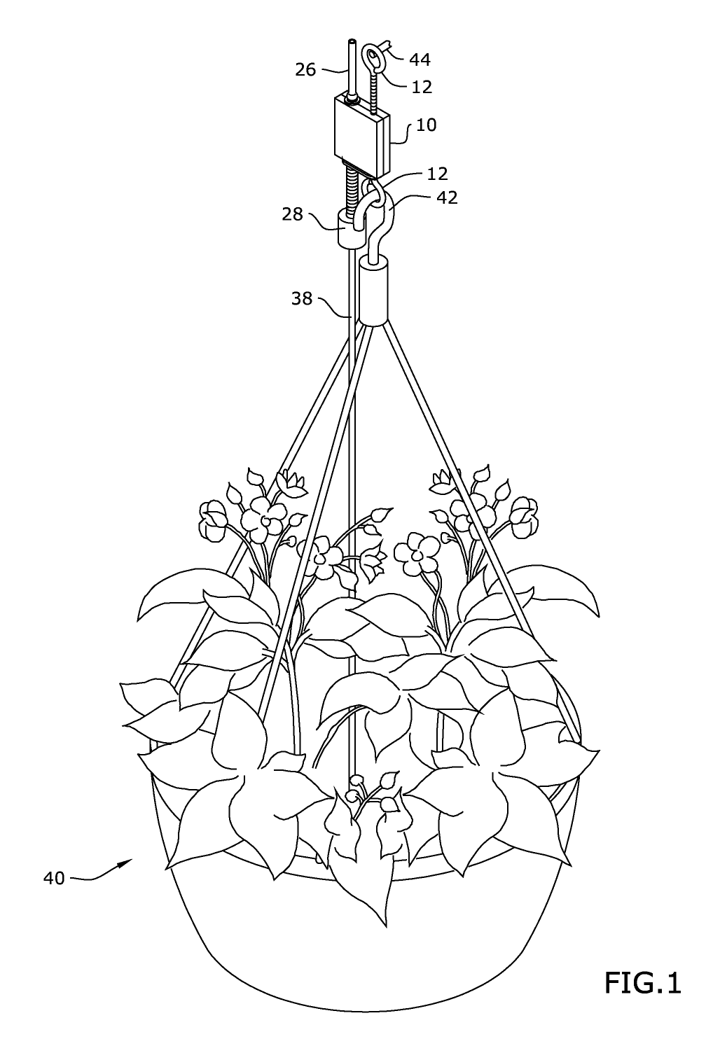

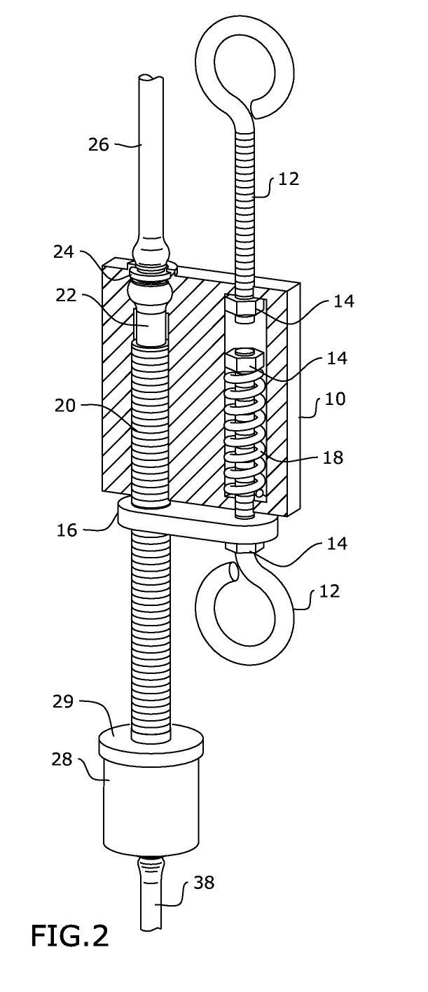

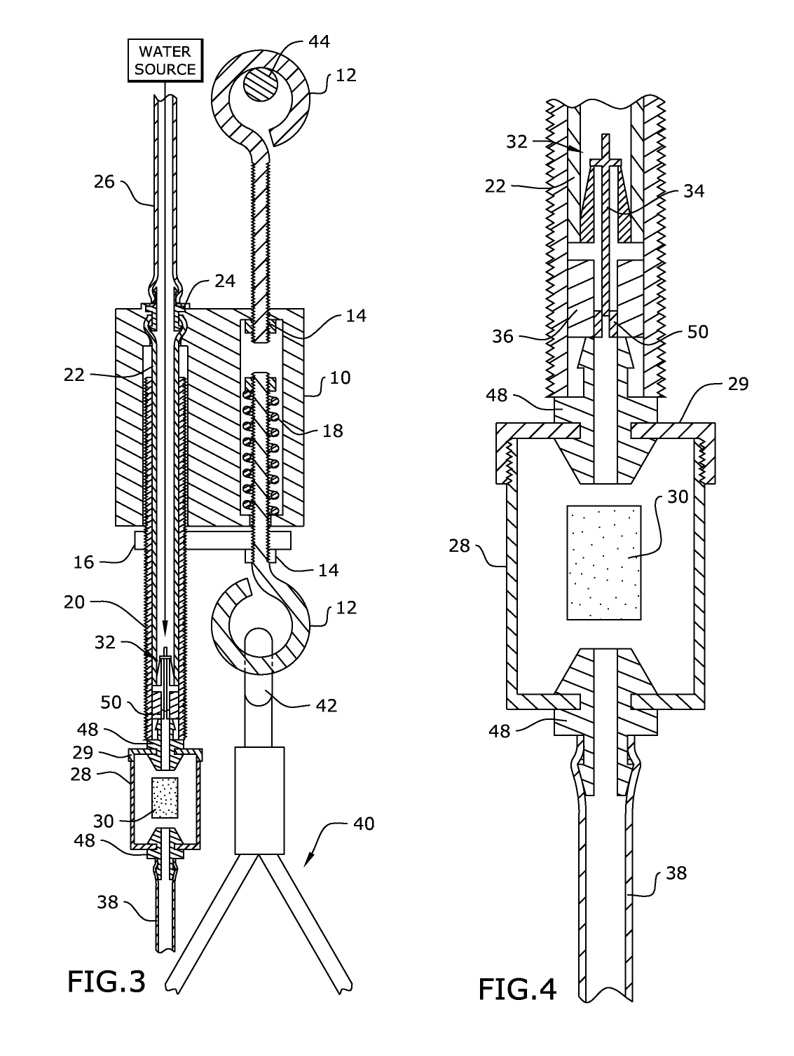

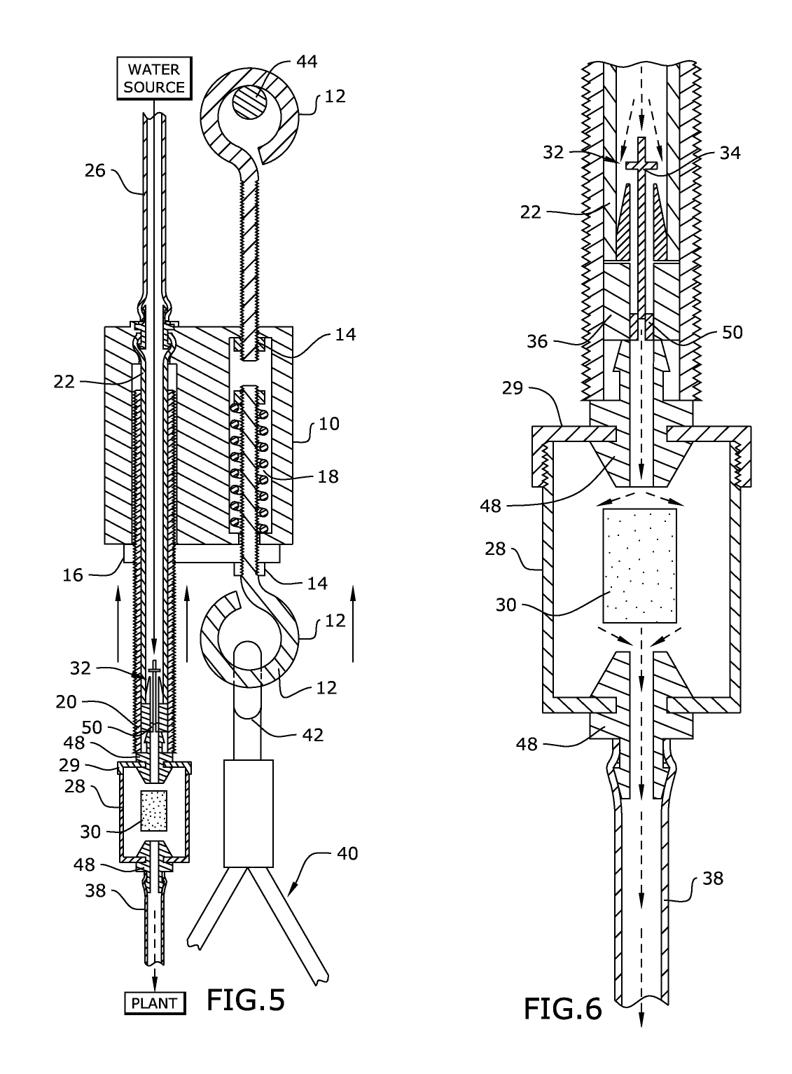

Referring to FIGS. 1 through 6, the present invention includes a hanging basket watering device. The watering device includes a housing 10. The housing 10 has a top portion and a bottom portion, with a first slot and a second slot formed from the top portion to the bottom portion. A first hook 12 includes a body and a head. The head is protruding from the bottom portion, and the body is slidably engaged with and resiliently retained within the first slot. The present invention further includes an interior tube 22 fixed within the second slot and protruding from the bottom portion of the housing 10. An exterior tube 20 surrounds and is slidably engaged with the interior tube 22. A bracket 16 is fixed to the exterior tube 20 and the second hook 12 near a bottom portion of the housing. A valve 32 is disposed within the interior tubing 22. The valve 32 is operable to close when a threshold force is applied against the resiliency of the first hook 12.

In certain embodiments, the present invention includes a second hook 12 fixed to and protruding from the top portion of the housing. The second hook 12 may be fixed to the first slot at the top portion by a retaining nut 14. The second hook 12 may be used to hang onto a support element 44. A hanging plant support element 42 may be hung from the first hook 12, applying a force against the resiliency of the first hook 12. Once the hanging plant 40 reaches a certain weight, the threshold force is met and the valve 32 is closed.

The interior tube 22 may be fluidly connected to a water source by a feed tube 26. In such embodiments, a tube fitting 24 may be secured to the top portion of the second slot and may be fluidly connected with the interior tube 22. The feed tube 26 is fluidly connected with the tube fitting 26, and delivers water into the interior tube 22. A drip tube 38 may be fluidly connected to the interior tube below the valve 32. Therefore, if the threshold force is not met, the valve 32 remains open and water is delivered to the hanging plant 40. The threshold force may be adjusted so that the valve 32 is closed when the hanging plant 40 is saturated with an optimal amount of water.

In certain embodiments, the first hook 12 may be resiliently secured within the first slot by a spring 18. In such embodiments, the spring 18 may include a larger diameter than an opening leading into the bottom of the first slot. The spring 18 may be disposed around the body of the first hook 12, and a nut 14 may be secured to the end of the first hook 12, thereby securing the spring 18 in between the nut 14 and the opening of the slot. The spring 18 may include a tension to provide for an optimal threshold force.

As mentioned above, the bracket 16 may be fixed to the first hook 12 and the exterior tube 20. In certain embodiments, an outer surface of the exterior tube 20 and the body portion the hook 12 may be threaded. The bracket 16 may include female threaded portions that mate with and secure to the outer surfaces of the exterior tube 20 and the first hook 12. A nut 14 may further secure the first hook 12 to the bracket 16.

Since the bracket 16 is fixed to both the exterior tube 20 and the hook 14, the exterior tube 20 and the hook 14 move with one another. When water within the hanging plant 40 evaporates and the weight of the hanging plant 40 decreases, the first hook 14 moves upward due to the resiliency of the spring 18. In turn, the exterior tube 20 slides upwards relative to the interior tube 22. A valve body 36 is fixed within the exterior tube 20. A valve stem 34 is secured within the valve body 36 by a stem slot 50. The valve body 36 and the valve stem 34 move upwards with the exterior tube 20, and expose an opening through the valve 32. Water is thereby able to flow through the valve 32 and through openings formed in the stem slot 50. The water then flows into the hanging plant 40. The weight of the water adds to the weight of the hanging plant 40, which applies an additional force to the resiliency of the hook 14. Once the threshold force has been met, the hook 14 moves downward and the exterior tube slides downward relative to the interior tube, closing the valve stem 34.

In certain embodiments, the present invention may further include a fertilizer housing 28. The fertilizer housing 28 may secure fertilizer 30 within. A screw cap 29 may be attached to the housing 28 to expose the inside of the housing 28 when removed. The fertilizer housing 28 may include an input fluidly connected to the interior tubing 22 by a tube fitting 48. The fertilizer housing 28 may include an output connected to the drip tube 38 via a second tube fitting 48. When the valve stem 34 is open, water may flow through the interior tubing 22, into the fertilizer housing 28 and into the drip tube 38. The water may thereby run through the fertilizer 30, and the present invention may deliver a portion of fertilizer 30 while watering the hanging plant 40.

It should be understood, of course, that the foregoing relates to exemplary embodiments of the invention and that modifications may be made without departing from the spirit and scope of the invention as set forth in the following claims.

What is claimed is:

1. A hanging basket watering device comprising:
a housing;
a first hook comprising a body and a head, wherein the head is protruding from a bottom portion of the housing and the body is slidably engaged with and resiliently retained within the housing;
an interior tube comprising at least a portion fixed within the housing;
an exterior tube surrounding and slidably engaged with the interior tube;
a bracket fixedly connecting the exterior tube and the second hook together near the bottom portion of the housing; and
a valve fluidly connected with the interior tube, wherein the valve is operable to close when a threshold force is applied against the resiliency of the first hook.

2. The hanging basket watering device of claim 1, further comprising a second hook fixed to and protruding from a top portion of the housing.

3. The hanging basket watering device of claim 1, further comprising a tube fitting secured to a top portion of the housing and fluidly connected with the interior tube.

4. The hanging basket watering device of claim 3, further comprising a feed tube fluidly connected with the tube fitting.

5. The hanging basket watering device of claim 1, further comprising a spring resiliently retaining the body of the first hook within the housing.

6. The hanging basket watering device of claim 1, further comprising a fertilizer housing having an input fluidly connected to the interior tubing and an output operable to direct fluid into a plant.

7. The hanging basket watering device of claim 6, further comprising a drip tube fluidly connected to the output of the fertilizer housing.

8. The hanging basket watering device of claim 7, further comprising a fertilizer tube fitting securing the exterior tube with the fertilizer housing.

9. The hanging basket water device of claim 1, wherein the exterior tubing and the first hook are attached to the bracket via threaded portions.
